(19) United States
(12) Patent Application Publication
(10) Pub. No.: US 2026/0080501 A1
(43) Pub. Date: Mar. 19, 2026

(54) IMAGE PROCESSING DEVICE AND METHOD

(71) Applicant: Smarter Silicon (Shanghai) Technologies Co., Ltd., Shanghai (CN)

(72) Inventors: Yuxuan LIU, Shanghai (CN); Lianjie WU, Shanghai (CN)

(21) Appl. No.: 19/322,124

(22) Filed: Sep. 8, 2025

(30) Foreign Application Priority Data
Sep. 19, 2024 (CN) 202411311927.7

(51) Int. Cl. G06T 3/40

(52) U.S. Cl. CPC G06T 3/40

(57) ABSTRACT

An image processing device includes a first memory, the first memory being used to store to-be-processed data of a plurality of first images; a scaling control component, the scaling control component being configured to read the to-be-processed data of the plurality of first images from the first memory, determine an image scaling factor corresponding to each of the first images, and send the to-be-processed data of each of the first images and its corresponding image scaling factor to a scaling component; and the scaling component, the scaling component being configured to perform scaling processing on the to-be-processed data of the corresponding first image based on the image scaling factor to obtain a target image, the target image including each target object in the first image, each target object being displayed in the target image based on a target ratio.

### CROSS-REFERENCES TO RELATED APPLICATION

This application claims priority to Chinese Patent Application No. 202411311927.7 filed on Sep. 19, 2024, the entire content of which is incorporated herein by reference.

### FIELD OF TECHNOLOGY

The present disclosure relates to the field of computer technology and, more specifically, to an image processing device and method.

### BACKGROUND

In a video conferencing scenario, the image data of multiple participants in the conference need to be reasonably displayed on the user's monitor. However, due to the large amount of image data generated in video conferencing and the possibility of various data transmission delays, the data processing speed is slow and requires a lot of computing resources. Therefore, there is a need to improve the image processing of multiple participants in a video conference.

### SUMMARY

One aspect of this disclosure provides an image processing device. The device includes a first memory, a scaling control component and a scaling component. The first memory is used to store to-be-processed data of a plurality of first images. The scaling control component is configured to read the to-be-processed data of the plurality of first images from the first memory, determine an image scaling factor corresponding to each of the first images, and send the to-be-processed data of each of the first images and its corresponding image scaling factor to a scaling component. The scaling component is configured to perform scaling processing on the to-be-processed data of the corresponding first image based on the image scaling factor to obtain a target image. The target image includes each target object in the first image, and each target object is displayed in the target image based on a target ratio.

Another aspect of this disclosure provides an image processing method. The method includes, reading, by a scaling control component in an electronic device, to-be-processed data of a plurality of first images from a first memory, and determining an image scaling factor corresponding to each of the first images; and performing, by a scaling component in the electronic device, scaling processing on the to-be-processed data of the corresponding first image based on the image scaling factor to obtain a target image, the target image including each target object in the first image, each target object being displayed in the target image based on a target ratio.

Another aspect of this disclosure provides an electronic device. The electronic device includes one or more processors and one or more memories coupled to the one or more processors and storing a plurality of computer instructions that, when being executed, cause the one or more processors to read to-be-processed data of a plurality of first images from a first memory, determine an image scaling factor corresponding to each of the first images, and perform scaling processing on the to-be-processed data of the corresponding first image based on the image scaling factor to obtain a target image. The target image includes each target object in the first image, and each target object is displayed in the target image based on a target ratio.

### BRIEF DESCRIPTION OF THE DRAWINGS

In order to provide a clearer illustration of various embodiments of the present disclosure or technical solutions in conventional technology, the drawings used in the description of the disclosed embodiments or the conventional technology are briefly described below. The following drawings are merely embodiments of the present disclosure. Other drawings may be obtained based on the disclosed drawings by those skilled in the art without creative efforts.

FIG. 1 is a schematic diagram of a video conferencing image processing method according to some embodiments of the present disclosure.

FIG. 2A is a video conferencing image including multiple participants.

FIG. 2B is a diagram showing multiple cutout images obtained after performing a cutout process on the video conference image in FIG. 2A.

FIG. 2C is a spliced image obtained by splicing the multiple cutout images in FIG. 2B using a conference application.

FIG. 3 is a schematic structural diagram of an image processing device according to some embodiments of the present disclosure.

FIG. 4 is a schematic structural diagram of another image processing device according to some embodiments of the present disclosure.

FIG. 5 is a schematic diagram of a corresponding relationship between a storage mode of multiple first images in a first memory and a display mode of the corresponding scaled images in a target image in the image processing device according to some embodiments of the present disclosure.

FIG. 6 is a schematic diagram of a state machine of a scaling control component in the image processing device according to some embodiments of the present disclosure.

FIG. 7 is a flowchart of an image processing method according to some embodiments of the present disclosure.

### DETAILED DESCRIPTION

To make the purposes, technical solutions, and advantages of the present disclosure clearer, the present disclosure is described in detail in connection with the accompanying drawings. The described embodiments should not be considered to limit the scope of the present disclosure. All other embodiments obtained by those skilled in the art without creative efforts are within the scope of the present disclosure.

In the following description, the term “some embodiments” describes a subset of all possible embodiments. “Some embodiments” can be a same subset or different subsets of all possible embodiments and can be combined with each other when there is no conflict.

In the following description, the terms “first,” “second,” and “third” are merely used to distinguish similar objects and do not represent a specific order. The terms “first,” “second,” and “third” can be interchanged in a specific sequence or order. Thus, embodiments of the present disclosure can be implemented in an order other than the order shown or described here.

Unless otherwise defined, all technical and scientific terms of the present disclosure have the same meaning as commonly understood by those skilled in the art. The terms used in the present disclosure are merely for the purpose of describing embodiments of the present disclosure and are not intended to limit the present disclosure.

In a conferencing scenario, multiple participants of a video conference participate in the video conference through multiple terminal devices. As shown in FIG. 1, multiple participants 121 participate in a video conference via multiple terminal devices 120. In this case, multiple terminal devices 120 transmit the locally collected video data to a server (not shown in FIG. 1) or the terminal devices 110 of other participants through the communication network 130. Since different terminal devices 120 have different acquisition environments, the ratios of the participants in the original images are different. If the images are directly displayed in the conference application of the terminal devices of other participants, these participants will be displayed at different display ratios. Therefore, there is a need to use the conference application running in the server or terminal device 110 to perform processing such as cutting, scaling and splicing on the images collected by each terminal device 120 to generate a conference screen 111 including multiple participants with a uniform display ratio.

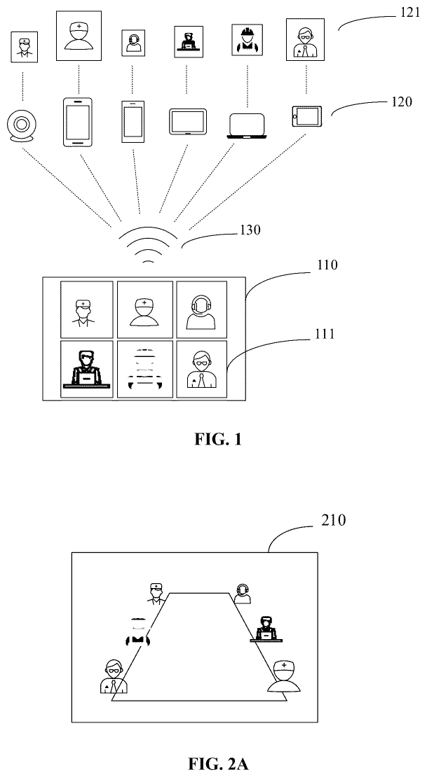

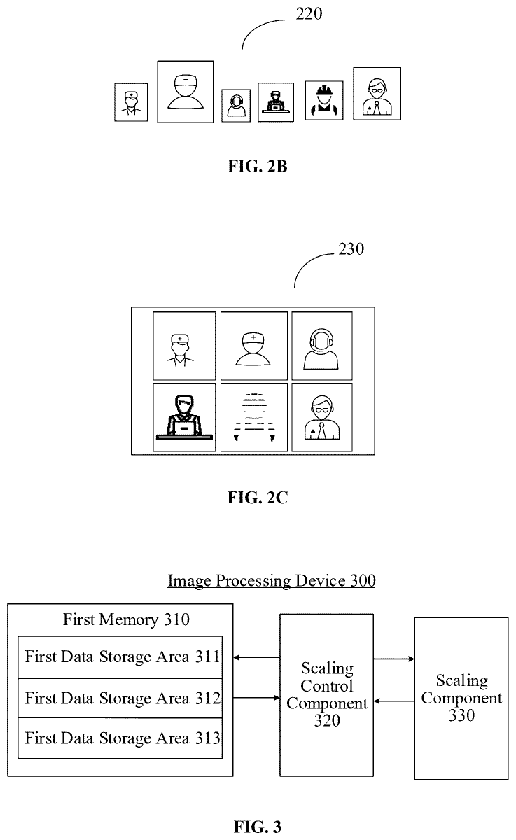

In another conferencing scenario, multiple participants in a video conference participate in the video conference through the same terminal device, that is, there are multiple participants in the same conference venue. As shown in FIG. 2A, when multiple conference participants are included in the same conference venue, an image 210 including multiple conference participants is captured by a camera device in the conference venue. Due to the different distances from the camera device, the display sizes of participants at different positions in the image are different, which affects the presentation effect. Therefore, there is a need to use the conference application to cut the image 210 output by the image acquisition device to obtain a plurality of cutout images 220 corresponding to each participant in the image 210 as shown in FIG. 2B. Subsequently, the conference application performs beautification, scaling, and splicing processing on each cutout image 220 to obtain an image 230. As shown in FIG. 2C, the display size of each participant in the image 230 is similar. Then, the spliced image 230 is transmitted to other venues through the communication network for display.

In both of the above conferencing scenarios, software processing methods are used to cut, clip, and splice the image data of multiple participants to obtain processed images that are arranged in an orderly manner and have similar display sizes. However, the transmission of image data from an image acquisition device (e.g., a camera) to a local conference application or a conference application in a remote device for processing is time-consuming. In addition, the splicing of image data using conference applications is software processing, which has a slow processing speed, thereby further reducing the image processing speed and bringing a bad user experience. Especially in real-time communication scenarios (such as conferencing scenarios) that require high image processing speed, long delays will seriously affect communication effects.

Based on this, embodiments of the present disclosure provide an image processing device. The device can be set in electronic devices with data processing capabilities such as conference machines, servers, laptops, tablet computers, desktop computers, smart TVs, set-top boxes, mobile devices (e.g., mobile phones, portable video players, personal digital assistants, dedicated messaging devices, portable gaming devices), etc.

FIG. 3 is a schematic structural diagram of an image processing device 300 according to some embodiments of the present disclosure. As shown in FIG. 3, the image processing device 300 includes a first memory 310, a scaling control component 320 and a scaling component 330.

In some embodiments, the first memory 310 can be used to store to-be-processed data of a plurality of first images.

In some embodiments, the first memory 310 may be a hardware memory in the image processing device for storing to-be-scaled image data.

In some embodiments, the first memory 310 may be a buffer or a high-speed buffer corresponding to the scaling control component 320 and the scaling component 330.

In some embodiments, the first memory 310 may also be an auxiliary memory installed in the image processing device.

The first image may be the to-be-processed image including the target object. In some embodiments, the first image may be a cutout image obtained by performing a cutout process on an original image including a plurality of target objects. The first image may also be a cutout image obtained by performing cutout processing on the plurality of target objects in multiple original images respectively. Each original image may include a target object.

In some embodiments, the first image may have corresponding object identification information, the object identification information being used to identify the state of the target object in the first image. For example, when the upstream application is a conference application, the upstream application can identify a designated target object in the plurality of target objects as the conference host. In another example, the speaking state of the plurality of target objects can be detected to determine the current speaker from the plurality of target objects, and the current speaker can be identified using the object identification information. In some embodiments, the object identification information may also be used as reference information for subsequent scaling processing of the image.

In some embodiments, the to-be-processed data of the first image may be all image data corresponding to the first image, or may be to part of the image data of the first image.

The to-be-processed data of the first image stored in the first memory 310 may be partial image data of the first image, which means, for example, that the first memory 310 stores pixel data of the first row to the N^{th} row of the first image. In this way, when a storage space of a specified size appears in the first memory 310, or after the scaling process is performed on the first to N^{th} rows of pixel data of the first image, the pixel data of the N+1^{th} to M^{th} rows of the first image can be stored in the first memory 310 as new to-be-processed data for the first image. N and M are both integers greater than 1.

In some embodiments, the scaling control component 320 may be configured to read the to-be-processed data of the plurality of first images from the first memory 310, determine the image scaling factor corresponding to each of the first images and send the to-be-processed data of each of the first images and its corresponding image scaling factor to the scaling component.

In some embodiments, the scaling control component 320 may be the hardware in the image processing device 300 for controlling the image scaling process.

In some embodiments, the scaling control component 320 may read the to-be-processed data of the first images from the first memory 310 based on the image processing state of the scaling component 330, and send the read to-be-processed data to the scaling component 330.

In some embodiments, the scaling control component 320 may communicate with a corresponding application (e.g., a conference application) to obtain the display size of the target image corresponding to the current plurality of first images, thereby determining the image scaling factor corresponding to each first image based on the display size of the target image and the size information of each first image.

In some embodiments, user configuration information may be received through the above application or the electronic device running the above application, and the display size of the target image may be determined based on the user configuration information.

In some embodiments, the size information of the display area used to display the target image in the operating interface of the above application can be obtained, and the display size of the target image can be determined based on the size information of the display area. For example, when the display area is a square area with an aspect ratio of 1:1, the display size of the target image can be set to a square image with an aspect ratio of 1:1. When the display area is a rectangular area with an aspect ratio of 2:1, the display size of the target image can be set to a square image with an aspect ratio of 2:1. In some embodiments, in response to a user's adjustment operation on the size information of the display area, the display size of the target image can be adjusted.

In some embodiments, the scaling control component 320 may communicate with a corresponding application (e.g., a conference application) to obtain an image scaling factor corresponding to each first image.

In some embodiments, each of the first images may have the corresponding original size information.

In this case, the scaling control component 320 may be further configured to obtain target size information preset for the target image, and determine the image scaling factor corresponding to each first image based on the original size information of each first image and the target size information.

In some embodiments, the scaling control component 320 may obtain the preset target size information for the target image from the upstream application, and determine the image scaling factor of each first image based on the target size information of the target image and the original size information of each first image.

In some embodiments, the scaling control component 320 may obtain the number information of the plurality of first images from the upstream application to determine the size information of each first image in the target image based on the target size information of the target image and the number information of the plurality of first images. Then, scaling control component 320 may determine the image scaling factor of each first image based on the size information of each first image in the target image and the original size information.

In some embodiments, the scaling control component 320 may include a configuration unit for storing multiple sets of image scaling factors. In some embodiments, the configuration unit in the scaling control component 320 may be implemented as a plurality of registers, each register being used to store a set of image scaling factors.

In this way, when the scaling control component 320 reads the to-be-processed data from the first memory 310 and sends it to the scaling component 330, the scaling control component 320 can input the image scaling factor corresponding to the to-be-processed data to the scaling component 330.

In some embodiments, the image scaling factor corresponding to the first image may include scaling factors in at least two directions, for example, a scaling factor in a horizontal direction and a scaling factor in a vertical direction.

In some embodiments, the scaling component 330 may be configured to perform scaling processing on the to-be-process data of the corresponding first image based on the scaling factor to obtain a target image. The target image may include each target object in the first image, and each target object may be displayed in the target image based on a target ratio.

In some embodiments, the scaling component 330 may be hardware for performing scaling processing on image data.

In some embodiments, after the scaling component 330 receives the first image and its corresponding image scaling factor from the scaling control component 320, the scaling component can perform scaling processing on the first image.

In some embodiments, the scaling component 330 may perform scaling processing on the first images in units of row pixels or column pixels of each first image. For example, a reduction process can be performed on the first image, that is, the number of pixels in the first image can be reduced.

In some embodiments, the target pixels displayed in the target image may be determined from the original pixels of the first image based on the reduction factor of the first image, and the determined target pixels can be filled into the target image. For example, when the rows and columns of the first image are both reduced by 2 times, a pixel can be selected as the target pixel every other pixel in the original pixels of the first image.

In some embodiments, the target pixels to be filled into the target image may be recalculated based on the reduction factor of the first image and the original pixels of the first image. For example, the first image includes M*N original pixels, and the reduced image corresponding to the first image includes m*n target pixels. First, the original pixels of the first image can be divided into multiple non-intersecting small blocks of (M/m)*(N/n) size; then, the average of each small block can be calculated, and the average can be used as the target pixel to be filled into the target image.

In another example, when the method is performed on the first image, the filling position of each original pixel in the first image in the target image may be determined based on the magnification corresponding to the first image, and at the same time, the calculated pixel values may be interpolated between the original pixels based on the specified interpolation algorithm.

In some embodiments, the specified interpolation algorithm may include a nearest neighbor interpolation algorithm, a bilinear interpolation algorithm, a bicubic interpolation algorithm, an edge-based image interpolation algorithm, a region-based image interpolation algorithm, etc.

In some embodiments, the scaling component 330 may perform scaling processing on the plurality of first images to be a target image, and the target image may include the target object in each first image. That is, the scaling component performs scaling processing on the multiple first images and stitches the scaling processing results corresponding to each first image into a target image.

In some embodiments, the display ratio of each target object in the target image may be the same or similar. For example, the display height of each target object in the target image may be the same or similar. In another example, the display position of each target object in the target image may be the same or similar. Similar display ratios may indicate that the difference in display ratios of the multiple target objects in the target image is within a preset difference threshold range.

In some embodiments, a corresponding display size may be set for each target object using an application program such that different target objects can have the same or different display proportions in the target image. For example, the display size of a specified target object (e.g., a conference host in a conference scene) in multiple target objects in the target image may be set to be larger than the display sizes of other target objects in the target image. In another example, the display size of the current speaker in multiple target objects in the target image may be set to be larger than the display sizes of other target objects, while the display sizes of the other target objects are the same.

Consistent with the present disclosure, the scaling control component can read the to-be-processed data of the plurality of first images from the first memory, determine the image scaling factor corresponding to each first image, and send the to-be-processed data of each first image and its corresponding image scaling factor to the scaling component. The scaling component can be used to perform scaling processing on the to-be-processed data of the corresponding first image based on the image scaling factor to obtain a target image. The target image can include each target object in the first image, and each target object can be displayed in the target image based on the target ratio. In this way, the scaling processing of multiple first images is completed and the target image is generated through the hardware components in the image processing device, and the target object in each first image is displayed in the target image based on the target ratio such that the scaling processing and splicing processing of the image are completed by the hardware circuit. The processed target image is given to the corresponding upstream application for display output, without the upstream application having to perform processing related to image scaling and stitching, which can greatly improve the image processing speed.

In some embodiments, the first memory 310 may include at least one first data storage area. The arrangement order of the at least one first data storage area may correspond to the order in which the scaling control component reads the image data from the first memory 310. Each of the first data storage areas may be used to store at least a piece of to-be-processed data of the first image. The scaled images corresponding to each of the first images can be arranged in an array in the target image, and the scaled images corresponding to at least one first image stored in the same first data storage area can be arranged along a first direction in the target image.

In some embodiments, at least one first data storage area in the first memory 310 may be arranged in sequence, and the arrangement order of the at least one first data storage area may correspond to the order in which the scaling control component 320 reads the image data from the first memory 310. For example, as shown in FIG. 3, the first memory 310 includes three first data storage areas arranged in sequence, namely, a first data storage area 311, a first data storage area 312, and a first data storage area 313. When the scaling control component 320 reads the to-be-processed data from the first memory 310, the data can be read sequentially in positive or reverse order based on the arrangement order of the address segments of the first data storage area 311, the first data storage area 312, and the first data storage area 313. In addition, when the first memory 310 uses a linked list structure to store the to-be-processed data, the scaling control component 320 can read data from each first data storage area in sequence based on the pointer in the linked list, without considering the positional relationship of the arrangement order of the actual storage area address segments of each first data storage area. For example, first, the data in the first data storage area 311 is read; then, based on the data pointer in the first data storage area 311 pointing to the first data storage area 313, the data in the first data storage area 313 is subsequently read. Then, based on the data pointer in the first data storage area 313 pointing to the first data storage area 312, the data in the first data storage area 312 is subsequently read.

In some embodiments, when the scaling control component 320 reads the to-be-processed data from the first memory 310, the scaling control component 320 may determine the first image to be processed next based on the first image currently being processed by the scaling component 330, and send a data source selection command to the first memory 310 based on the storage address information of the to-be-processed data of the first image to be processed next. If there is to-be-processed data in the first data storage area specified by the scaling control component 320, the first storage 310 may return a reply message to the scaling control component 320 indicating that the data is valid. Then, the scaling control component 320 may send a ready command to the first memory 310 and directly read the to-be-processed data from the first memory 310.

Each first data storage area may be used to store the to-be-processed data of at least one first image, that is, in the process of generating a target image using the image processing device 300, each first data storage area can be used to cache the to-be-processed data of one or more first images.

In some embodiments, the scaled images corresponding to each first image may be arranged in an array in the target image, which may include arranging the scaled images corresponding to each first image in the target image in a linear array, a rectangular array, a circular array, a Z-shaped array, an F-shaped array, or any other type of array arrangement.

For example, when the target image corresponds to a rectangular array arrangement and the first direction is the longitudinal direction of the rectangular array, the scaled image corresponding to at least one first image stored in the same first data storage area can be arranged along the longitudinal direction of the rectangular array in the target image. In another example, when the target image corresponds to a circular array arrangement and the first direction is a radius extension direction of the circular array, the scaled image corresponding to at least one first image stored in the same first data storage area can be arranged in the target image along the radius extension direction of the circular array. In another example, when the target image corresponds to a Z-shaped array arrangement and the first direction is the longitudinal direction of the Z array, the scaled image corresponding to at least one first image stored in the same first data storage area can be arranged along the longitudinal direction of the Z shape in the target image.

As shown in FIG. 3, when the target image is arranged in a rectangular array and the first direction is the longitudinal direction of the rectangular array, the scaled images corresponding to at least one first image stored in the first data storage area 311 are arranged in the same column (for example, the first column) in the target image. By analogy, the scaled images corresponding to at least one first image stored in the first data storage area 312 and the first data storage area 313 are respectively arranged in the same column (for example, the second column and the third column) in the target image.

In the above embodiment, by dividing the first memory into at least one first data storage area, the scaled images of the plurality of first images can be arranged in an orderly manner in the target image.

FIG. 4 is a schematic structural diagram of an image processing device 400 according to some embodiments of the present disclosure. As shown in FIG. 4, the image processing device 400 includes a second memory 410, a read control component 420, a first memory 430, a scaling control component 440 and a scaling component 450.

In some embodiments, the second memory 410 can be used to store a plurality of to-be-processed first images.

In some embodiments, the read control component 420 may be configured to read idle state information of the first memory 430, and read the to-be-processed data of at least one first image from the second memory 410 and store the read to-be-processed data of the at least one first image in the first memory 430 when the idle state information indicates that the first memory 430 has an idle storage space not less than a specified threshold.

In some embodiments, the second memory 410 may be a memory used to store complete image data of a plurality of first images.

In some embodiments, the second memory 410 may be a memory of the image processing device 400, for example, a double data rate synchronous dynamic random-access memory (DDR SDRA).

In some embodiments, the first image stored in the second memory 410 may be an image including a plurality of target objects. In this way, before scaling the first image using the scaling component 450, a cutout process needs to be performed on the first image to determine a cutout image of each target object in the first image, and then a scaling process can be performed on each cutout image using the scaling component 450.

In some embodiments, the first image stored in the second memory 410 may be an image after performing a cutout process on an original image including a plurality of target objects.

In some embodiments, the first image stored in the second memory 410 may be image data acquired by a local image acquisition device, or may be image data acquired by an image acquisition device of another electronic device through a data communication path.

For example, when the image processing device 400 is a conference machine, the camera of the conference machine can be used to collect video data of the scene, the target object in each frame of the video data can be cut out, and the image including the target object obtained after the cutout process can be stored as the first image in the second memory 410. In another example, when the image processing device 400 is a personal computer (PC), the PC can acquire image data from a plurality of image acquisition devices via a wired or wireless network, perform a cutout process on a target object in the acquired image data, and store an image including the target object obtained after the cutout process as a first image in the second memory 410.

In some embodiments, the read control component 420 may be hardware in the image processing device for controlling the process of reading data from the second memory 410.

In some embodiments, the read control component 420 may read the idle state information of the first memory 430 in real time or periodically to determine whether to read the to-be-processed data from the second memory 410 based on the idle state information of the first memory 430 and store the read to-be-processed data in the first memory 430.

The idle storage space of the specified threshold may be the minimum storage space for the read control component 420 to store data in the first memory 430.

In some embodiments, the idle storage space of the specified threshold may be determined in units of the storage space occupied by a row of pixels of the first image with the smallest data volume, or may be determined based on the minimum data size that the scaling component can process.

In some embodiments, the read control component 420 may read the to-be-processed data from the second memory 410 in units of images, that is, the read control component 420 may read the complete to-be-processed data of at least one first image from the second memory 410 each time.

In some embodiments, the read control component 420 may read the to-be-processed data from the second memory 410 in units of at least one row of pixels.

In some embodiments, a burst mode may be set for the read control component 420 to read a larger amount of to-be-processed data from the second memory 430.

In some embodiments, when the read control component 420 determines that the first memory 430 has idle storage space not less than a specified threshold based on the idle state information of the first memory 430 read, the read control component 420 may send a data read command to the second memory 410, and carry the address information of the to-be-processed data to be read in the data read command. Then, the read control component 420 can read the to-be-processed data of at least one first image from the corresponding storage address of the second memory 410.

In the foregoing embodiment, the second memory 430 is a memory (e.g., a DDR SDRA) and the first memory 410 is a cache, since the transfer rate and operating frequency of memory chips are low, therefore, the to-be-processed data of at least one first image in the first memory 430 may be pre-read to the first memory 430 for caching by the read control component 420. In this way, the scaling control component 440 can obtain the to-be-processed data at a higher frequency, thereby reducing the data transmission delay caused by the low access rate of the second memory 410.

In some embodiments, the read control component 420 may be used to store the read to-be-processed data of each first image in the corresponding first data storage area based on the reading order of the to-be-processed data of the at least one first image read from the second memory 410 and the arrangement order of the at least one first data storage area.

In some embodiments, the order in which the read control component 420 reads the to-be-processed data of at least one first image may be determined based on the storage order and/or storage time of at least one first image in the second memory 410.

In some embodiments, the order in which the read control component 420 reads the to-be-processed data of at least one first image may be determined based on the identification information of at least one first image. For example, the read control component 420 may obtain the reading order information corresponding to the plurality of first images from the upstream application, and then read the to-be-processed data of the plurality of first images in sequence based on the obtained reading order information based on the identification information of the plurality of first images.

In some embodiments, when the read control component 420 reads the to-be-processed data of the first image from the second memory 410 in units of at least one row of pixel data, the read control component 420 can store the to-be-processed data belonging to the same first image in the same first data storage area.

For example, as shown in FIG. 4, after the detecting that the first data storage area 431 has idle storage space not less than the specified threshold, the read control component 420 reads the first row of pixel data corresponding to the image A from the second memory 410 and stores it in the first data storage area 431. Then, after detecting that the first data storage area 432 has idle storage space not less than the specified threshold, the read control component 420 reads the first row of pixel data corresponding to the image B from the second memory 410 and stores it in the first data storage area 432. When the read control component 420 detects that the first data storage area 431 has idle storage space not less than the specified threshold, the second row of pixel data corresponding to the image A is read from the second memory 410 and stored in the first data storage area 431.

In some embodiments, the plurality of first images may include a plurality of first sub-images, and the to-be-processed data of the plurality of first sub-images may be stored in different first data storage areas.

For example, when the first sub-images of the first images are image C, image D and image E respectively, the to-be-processed data of the first sub-images can be stored in different first data storage areas. That is, for example, image C, image D, and image E can be respectively stored in the first data storage area 311, the first data storage area 312, and the first data storage area 313 as shown in FIG. 3.

In some embodiments, the scaling control component 320 may be configured to read at least part of the to-be-processed data of each first sub-image from each first data storage area based on the arrangement order of the at least one first data storage, and send at least part of the to-be-processed data of each first sub-image to the scaling component 330 for scaling processing, the scaled images corresponding to the plurality of first sub-images being arranged along a second direction in the target image, the second direction being different from the first direction.

In some embodiments, the scaling control component 320 may read the to-be-processed data processed from at least one first data storage area in sequence based on the arrangement order of at least one first data storage area in the first memory 310, and send the to-be-processed data and the corresponding image scaling factor to the scaling component. In this way, the scaling component 330 can perform image scaling processing based on the to-be-processed data and the corresponding image scaling factor.

Continue with the previous example. After the scaling control component 320 reads the to-be-processed data of image C from the first data storage area 311, the scaling control component 320 sends the to-be-processed data of image C to the scaling component 330, and configures the image scaling factor corresponding to image C for the scaling component 330 such that the scaling component 330 can perform scaling processing on the to-be-processed data of image C based on the configured image scaling factor. Then, the scaling control component 320 can sequentially process the to-be-processed data of image D and image E in the first data storage areas 312 and 313 based on the same steps.

In some embodiments, in the target image after the scaling process, a plurality of first sub-images stored in different first data storage areas may be arranged along the second direction. For example, when the scaled images in the target image are arranged in a rectangular array, image C, image D, and the scaled image corresponding to image D may be arranged in the horizontal or vertical direction of the rectangular array in the target image.

At the same time, the second direction may be different from the first direction described above. That is, the arrangement direction of the scaled image corresponding to at least one first image stored in the same first data storage area in the target image may be different from the arrangement direction of the scaled image corresponding to at least one first image stored in different first data storage areas in the target image. For example, when the scaled images in the target image are arranged in a rectangular array, the first direction may represent the longitudinal direction of the rectangular array, and the second direction may represent the transverse direction of the rectangular array.

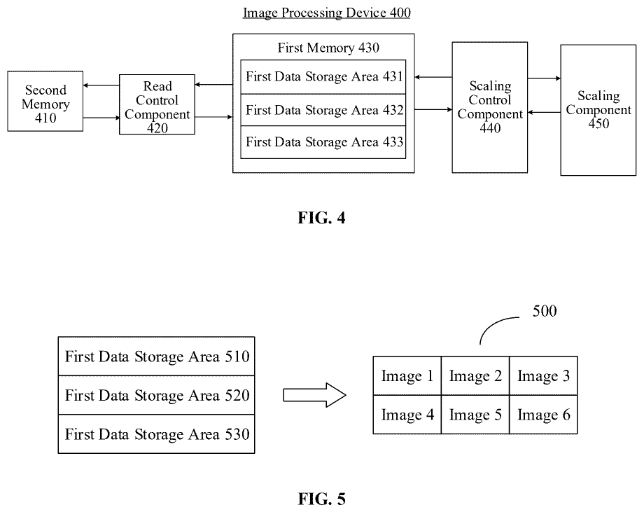

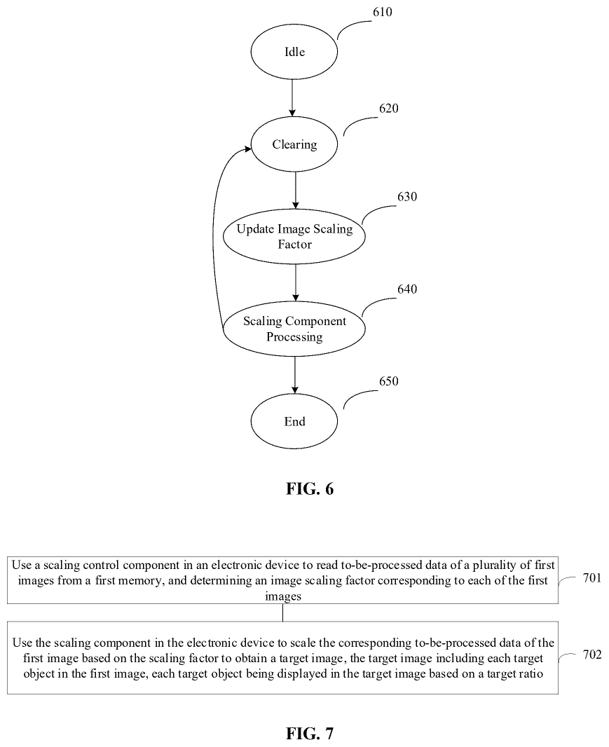

As shown in FIG. 5, the first memory includes three first data storage areas, namely, a first data storage area 510, a first data storage area 520, and a first data storage area 530. Before generating the target image 500, the first data storage area 510 can be used to store the to-be-processed data of image 1 and image 4, the first data storage area 520 can be used to store the to-be-processed data of image 2 and image 5, and the first data storage area 530 can be used to store the to-be-processed data of image 3 and image 6.

After the scaling processing by the scaling component, the scaled images corresponding to the images stored in the same first data storage area can be arranged in the target image 500 along the vertical direction. That is, the scaled images corresponding to image 1 and image 4 are in the same column in the target image 500, the scaled images corresponding to image 2 and image 5 are in the same column in the target image 500, and the scaled images corresponding to image 3 and image 6 are in the same column in the target image 500. At the same time, the scaled images corresponding to the images stored in different first data storage areas can be arranged horizontally in the target image 500. That is, the scaled images corresponding to image 1, image 2, and image 3 are in the same row in the target image 500, and the scaled images corresponding to image 4, image 5, and image 6 are in the same row in the target image 500.

Since the target image processed by the scaling component needs to be sent to the corresponding rendering component (e.g., a graphics processing unit (GPU)) for rendering, when the rendering component renders the target image by pixel row, after the scaling control component reads the to-be-processed data from the first data storage areas 510, 520 and 530 in sequence and sends them to the scaling component for scaling processing, the scaling component can arrange the pixels in the generated target image in pixel rows. After forming part of the pixel row data of the target image, the pixels of the generated target image can be sent to the GPU for rendering in a timely manner based on the pixel row, without waiting for the reception to obtain all the data of the target image before rendering. In this way, a pipelined image processing flow is formed from the scaling control component, the scaling component to the rendering component, and each component completes a part of the image processing task, which can significantly improve the image processing efficiency.

In this way, the arrangement of the scaled images corresponding to the plurality of first images in the target image can be determined by the arrangement order of at least one first data storage area in the first memory and the data reading order of the scaling control component, thereby achieving the purpose of determining the image output effect by using the hardware device.

In some embodiments, as shown in FIG. 4, the upstream application can send the display format information related to the target image to the read control component 420. The display format information may include at least the number of first images corresponding to each row in the target image along the second direction. For example, when the second direction is the horizontal direction of the target image, the display format information may include at least the number of first images corresponding to each row in the target image.

In this way, the read control component 420 can determine at least one first data storage area from a plurality of data storage areas of the first memory 430 based on the display format information, and use the at least one first data storage area to store the to-be-processed data of the plurality of first images. For example, when the display format information indicates that each row in the target image corresponds to three first images, the read control component 420 can determine three data storage areas from the plurality of data storage areas in the first memory 430 as the first data storage areas.

In the above embodiment, after the scaling control component 440 reads at least a part of the to-be-processed data of each first sub-image from each first data storage area based on the arrangement order of at least one first data storage area, and sends the data to the scaling component 450, the scaling component 450 can store the plurality of first sub-images in different first storage areas, and arrange the scaled images of the plurality of first sub-images along the second direction in the target image.

In some embodiments, the plurality of first images may include a second sub-image and a third sub-image. The first data storage area corresponding to the second sub-image may be arranged before the first data storage area corresponding to the third sub-image.

For example, as shown in FIG. 3, the second sub-image is an image stored in the first data storage area 311, and the third sub-image is an image stored in the first data storage area 312.

In some embodiments, the scaling control component 320 may be configured to, in response to a scaling processing completion signal output by the scaling component 330 for the first part of the data of the second sub-image, read the second part of the data of the third sub-image from the first memory 310 and determine the image scaling factor corresponding to the third sub-image. The amount of the first part of the data may be determined based on the image scaling factor corresponding to the second sub-image, and the amount of the second part of the data may be determined based on the image scaling factor corresponding to the third sub-image. The scaling control component 320 may be configured to send the read second part of the data and its corresponding image scaling factor to the scaling component.

In some embodiments, after receiving the signal that the scaling process of the first part of the data of the second sub-image is completed by the scaling component 330, the scaling control component 320 may read the second part of the data of the third sub-image stored in the next first data storage area based on the arrangement order of at least one first data storage area in the first memory 310 and determine the corresponding image scaling factor. In this way, cross-reading of the to-be-processed data in at least one first data storage area is achieved, and then the to-be-processed data in at least one first data storage area is cross-processed by using the scaling component 330.

At the same time, the amount of the to-be-processed data read by the scaling control component 320 can be determined based on the corresponding image scaling factor.

For example, the scaling factor corresponding to the second sub-image is 2, and the scaling factor corresponding to the third sub-image is ½, that is, the second sub-image is enlarged by 2 times, and the third sub-image is reduced by 2 times. In this way, in order to enable the scaling component 330 to generate the target image in units of rows of pixels, the scaling control component can read 1 row of pixel data of the second sub-image as the first part of data, and read 4 rows of pixel data of the third sub-image as the second part of data. In this way, the scaling component 330 can generate two lines of pixel data in the target image based on the first part of the data and the second portion of the data.

In some embodiments, the scaling component 330 may be further configured to generating first indication information in response to completing the scaling process for the first part of the data of the second sub-image, the first indication information being used to indicate processing position information for at least a part of the received image data of the second sub-image.

Since the target image includes the scaled data of multiple first images, the scaling component 330 needs to switch to the to-be-processed data of different first images for scaling processing when generating the target image. For example, after scaling component 330 receives the first portion of the data of the second sub-image from the scaling control component 320 and performs scaling processing, the zoom component 330 may switch to processing the second part of the data of the third sub-image received from the scaling control component 320.

In order for the scaling component 330 to accurately locate the processing position of the second sub-image when it continues to process the next part of the data of the second sub-image, the scaling component 330 may generate information for indicating the current processing position for at least part of the image data of the received second sub-image, that is, the first indication information. In this way, when the next part of the data of the second sub-image is subsequently processed, the processing can be continued from the breakpoint position.

In some embodiments, the first indication information may be row count information (i.e., V-count), which is used to indicate the number of rows that have been processed.

In some embodiments, the scaling component 330 may include a third memory. The third memory can be used to store processed data of at least one first image corresponding to at least one row of pixels along the second direction in the target image.

The scaling component 330 can cross-process the to-be-processed data of the plurality of first images based on the arrangement order of at least one first data storage area in the first memory 310 such that the scaled processed images of the plurality of first images stored in different first data storage areas can be arranged along a second direction (e.g., horizontally) in the target image. Therefore, a third memory is provided in the scaling component 330 for storing processed data of at least one first image data corresponding to at least one row of pixels in the target image along the second direction received by the scaling component 330 from the scaling control component 320. In this way, when the scaling component 330 generates the next row of pixels along the second direction in the target image, the processed data stored in the third memory may be referred to.

In some embodiments, the scaling control component 320 may be further configured to updating the second data set stored in the third memory using the first data set in response to the scaling component 330 completing the scaling process of the first data set of at least one first image, the second data set representing image data of at least one first image that precedes the first data set in the processing order.

In some embodiments, the first data set and the second data set may respectively represent image data of at least one first image corresponding to at least one row of pixels in the target image, and the image data corresponding to the second data set may be scaled before the image data corresponding to the first data set.

In this way, when performing scaling processing on the first data set, the scaling component 330 needs to refer to the second data set stored in the third memory such that at least one row of pixels in the target image generated based on the first data set can match at least one row of pixels in the target image generated based on the second data set.

At the same time, in response to the scaling component 330 completing the scaling process on the first data set, the scaling control component 320 can update the second data set in the third storage area using the first data set. That is, the second data set in the third memory is cleared, and the first data set is stored in the third memory such that the first data set can be used as a reference when the scaling component 330 generates the next row of pixels in the target image.

In some embodiments, the third can also be used to store the pre-scaling data corresponding to the previously processed pixels in the same row of pixels in the target image.

For example, as shown in FIG. 5, when the scaling component 330 generates the first row of pixels of the target image 550, the scaling component 330 first performs scaling processing on part of the to-be-processed data of the image 1 in the first data storage area 510, and stores the processed image data of the image 1 in the third storage area 510. Then, when the scaling component 330 processes part of the to-be-processed data of the image 2 in the second data storage area 520, the image data of the image 1 stored in the third memory may be used as a reference.

Next, the state machine of the scaling control component in the image processing device provided by the present disclosure will be described in conjunction with FIG. 6.

FIG. 6 is a schematic diagram of a state machine of a scaling control component in the image processing device according to some embodiments of the present disclosure.

As shown in FIG. 6, when there is no current image processing task, the scaling control component is in an idle state 610.

After receiving the image processing task, the scaling control component starts to read the to-be-processed data of the first image from the first memory (frame_start), and enters the clearing state 620 (clr) to clear the parameter configuration information of the component, for example, the parameter configuration information for the image scaling factor.

After the scaling control component reads the to-be-processed data of the first image, it determines the image scaling factor corresponding to the first image and enters the update image zoom factor state 630 (update coef) to update the image scaling factor corresponding to the first image to the scaling component.

During the period when the scaling component performs scaling processing on the to-be-processed data of the first image, the scaling control component enters the scaling component processing state 640 (scaler_proc) to wait for a signal indicating that the scaling component has completed scaling processing on the to-be-processed data of the current first image.

After the scaling component completes the scaling processing of the to-be-processed data of the current first image, the scaling component sends a processing completion signal (part_le) to the scaling control component such that the scaling control component can read the to-be-processed data of the next first image from the first memory again and re-enters the clearing state 620.

After the scaling component generates a complete frame of the target image, the scaling component sends a signal (o_fe) indicating that the processing of the entire frame of the image is completed to the scaling control component, and the scaling control component enters the end state 650 (end).

The image processing device provided by the embodiments of the present disclosure may also include a driver. The driver may be used to read the target image from the scaling component to send the target image to the corresponding upstream application for display output.

In the image processing device provided in the present disclosure, hardware is used to perform scaling and splicing processing on multiple first images such that the driver can directly obtain the scaled and spliced target image from the hardware (i.e., the scaling component), and then send the target image to the upstream application.

In some embodiments, the driver may read and output the target image from the scaling component in units of at least one row of pixels.

In some embodiments, in response to the number of pixels of the target image obtained after processing by the scaling component being not less than a number threshold, the driver may read and output the target image from the scaling component, the number threshold representing a minimum number of pixels of the target image that the driver reads from the scaling component.

Embodiments of the present disclosure also provide an image processing method. The method can be executed by a processor of a computer device equipped with the image processing described above. The computer device may be a conference machine, a server, a laptop, a tablet computer, a desktop computer, a smart TV, a set-top box, a mobile device (such as a mobile phone, a portable video player, a personal digital assistant, a dedicated messaging device, a portable gaming device) and other devices with image processing capabilities.

FIG. 7 is a flowchart of an image processing method according to some embodiments of the present disclosure. The method will be described in detail below.
701, using the scaling control component in the electronic device to read the to-be-processed data of a plurality of first images from the first memory, and determining the image scaling factor corresponding to each of the first images.
702, using the scaling component in the electronic device to scale the corresponding to-be-processed data of the first image based on the scaling factor to obtain a target image, the target image including each target object in the first image, each target object being displayed in the target image based on a target ratio.

In some embodiments, the first memory may include at least one first data storage area. The arrangement order of the at least one first data storage area may correspond to the order in which the scaling control component reads the image data from the first memory.

Each of the first data storage areas may be used to store at least a piece of to-be-processed data of the first image. The scaled images corresponding to each of the first images can be arranged in an array in the target image, and the scaled images corresponding to at least one first image stored in the same first data storage area can be arranged along a first direction in the target image.

In some embodiments, the image processing method may further include using the read control component to read the idle state information of the first memory; using the read control component to read the to-be-processed data of at least one first image from the second memory, and storing the to-be-processed data of the at least one first image read in the first memory when the idle state information indicates that the first memory has an idle storage space not less than a specified threshold, the second memory being used to store a plurality of to-be-processed first images.

In some embodiments, using the read control component to read the to-be-processed data of at least one first image from the second memory, and storing the read to-be-processed data of the at least one first image to the first memory may include using the read control component to store the to-be-processed data of each read first image into the corresponding first data storage area based on the reading order of the to-be-processed data of the at least one first image read by the read control component from the second memory and the arrangement order of the at least one first data storage area.

In some embodiments, the plurality of first images may include a plurality of first sub-images, and the to-be-processed data of the plurality of first sub-images may be stored in different first data storage areas.

In some embodiments, using the scaling control component in an e to read the to-be-processed data of the plurality of first images from the first memory may include reading at least part of the to-be-processed data of each first sub-image from each first data storage area based on the arrangement order of the at least one first data storage area, the scaled images corresponding to the plurality of first sub-images being arranged along a second direction in the target image, the second direction being different from the first direction.

In some embodiments, the plurality of first images may include a second sub-image and a third sub-image. The first data storage area corresponding to the second sub-image may be arranged before the first data storage area corresponding to the third sub-image.

In some embodiments, the method may further include using the scaling control component to read the second part of the data of the third sub-image from the first memory and determining the image scaling factor corresponding to the third sub-image in response to a scaling processing completion signal output by the scaling component for the first part of the data of the second sub-image. The amount of the first part of the data may be determined based on the image scaling factor corresponding to the second sub-image, and the amount of the second part of the data may be determined based on the image scaling factor corresponding to the third sub-image. In some embodiments, the method may further include using the scaling control component to send the second part of the data that was read and its corresponding image scaling factor to the scaling component.

In some embodiments, the method may further include generating the first indication information using the scaling component in response to the completion of the scaling process for the first part of the data of the second sub-image, the first indication information being used to indicate processing position information for at least a part of the received image data of the second sub-image.

In some embodiments, the scaling component may include a third memory. The third memory can be used to store processed data of at least one first image corresponding to at least one row of pixels along the second direction in the target image.

In some embodiments, the method may further include using the scaling control component to update the second data set stored in the third memory using the first data set in response to the scaling component completing the scaling process of the first data set of at least one first image, the second data set representing image data of at least one first image that precedes the first data set in a processing order.

In some embodiments, each of the first images may have the corresponding original size information.

In some embodiments, the method may further include using the scaling control component to obtain the target size information preset for the target image, and determining the image scaling factor corresponding to each of the first images based on the original size information of each of the first images and the target size information.

In some embodiments, the method may further include using a driver to read the target image from the scaling component, and sending the target image to a corresponding application for display output.

The description of the above method embodiment is similar to the description of the above device embodiment and has similar beneficial effects as the device embodiment. For technical details not disclosed in the method embodiment of the present disclosure, reference can be made to the description of the device embodiment of the present disclosure.

In the present disclosure, if the image processing method is implemented as a software functional module and sold or applied as an independent product, the method can be stored in a computer-readable storage medium. Thus, the technical solutions of the present disclosure or the parts contributing to the existing technology can essentially be embodied in the form of a software product. The software product can be stored on a storage medium and include multiple instructions for enabling an electronic device (e.g., a personal computer, a server, or a network device) to execute some or all of the methods of embodiments of the present disclosure. The storage medium can include various media capable of storing program codes, such as a USB drive, an external hard drive, a read-only memory (ROM), a disk, or an optical disc. Therefore, embodiments of the present disclosure are not limited to any specific hardware, software or firmware, or any combination of hardware, software and firmware.

Embodiments of the present disclosure also provide a computer device having a memory and a processor. The memory stores a computer program that, when executed by the processor, causes the processor to implement some or all of the steps in the method described above.

Embodiments of the present disclosure also provide a computer-readable storage medium storing a computer program that, when executed by the processor, causes the processor to implement some or all of the steps in the method described above. The computer-readable storage medium can be transient or non-transient.

Embodiments of the present disclosure provide a computer program including computer-readable codes. When the computer readable code is executed in a computer device, a processor in the computer device executes some or all of the steps in the above method.

Embodiments of the present disclosure provide a computer program product, including a non-transient computer-readable storage medium storing the computer program that, when read and executed by a computer, causes the computer to perform some or all of the steps of the method above. The computer program product can be implemented by hardware, software, or a combination thereof. In some embodiments, the computer program product can be embodied as a computer storage medium. In some other embodiments, the computer program product can be embodied as a software product, such as a software development kit (SDK).

The description of embodiments of the present disclosure tends to highlight the differences between embodiments of the present disclosure, and same or similar parts can be referred to each other. The description of the device, storage medium, computer program, and computer program product are similar to the description of the method embodiments and have similar beneficial effect as the method embodiments. For the technical details not described in embodiments of the device, storage medium, computer program, and computer program product of the present disclosure, reference can be made to the description of the method embodiments.

The term “an embodiment” or “one embodiment” mentioned throughout the specification means that specific features, structures, or characteristics related to the embodiment are included in at least one embodiment of the present disclosure. Therefore, “in one embodiment” or “in an embodiment” in various parts of the specification do not necessarily refer to the same embodiment. In addition, these specific features, structures, or characteristics can be combined in various suitable methods in one or more embodiments. In various embodiments of the present disclosure, the numbered processes do not imply a specific order of execution. The execution order of the processes should be determined by their functionality and internal logic, and should not be considered as a limitation on the implementation processes of embodiments of the present disclosure. The numbering of embodiments of the present disclosure is merely for descriptive purposes and does not imply any superiority or preference of embodiments of the present disclosure.

The terms “comprise,” “include,” or any variations thereof are intended to encompass non-exclusive inclusion. Thus, a process, a method, an item, or a device that includes a series of elements can include additional elements not explicitly listed, or can include other elements inherent to the process, method, item, or device. When there is no more limitation, an element defined by “including an . . . ” does not exclude another identical element in the process, method, item, or device including the element.

In embodiments of the present disclosure, the disclosed device and method can be implemented in other methods. The device embodiments described above are illustrative. For example, the division of the units is merely a logical function division. In some embodiments, other division methods can exist, e.g., a plurality of units or assemblies can be combined or integrated in another system, or some features can be ignored or not be performed. In addition, the coupling, direct coupling, or communicative connection between the various components discussed or illustrated can be indirect coupling or communicative connection through some interfaces, devices, or units, and can be electrical, mechanical, or in another manner.

The units described as separate components may be or may not be physically separated. The components shown as the units may be or may not be physical units, and can be located in one place or distributed over a plurality of network units. Some or all of the units can be selected as needed to implement the purpose of the technical solution of embodiments of the present disclosure.

In addition, the functional units of embodiments of the present disclosure can be integrated in a processing unit or can be used as independent units, respectively. In some embodiments, two or more units can be integrated into one unit. The integrated unit can be implemented by hardware or a combination of hardware and a software functional unit.

Those of ordinary skill in the art can understand that all or some processes of method embodiments can be performed by the program instructing related hardware. The program can be stored in the computer-readable storage medium. When the program is executed, the processes of method embodiments can be performed. The storage medium can include various media capable of storing program codes, such as a mobile storage device, a read-only memory (ROM), discs, or optical discs.

In some other embodiments, if the integrated unit is implemented as a software functional module and sold or used as an independent product, the integrated unit can also be stored in a computer-readable storage medium. Based on this understanding, the technical solutions disclosed here or parts contributing to the existing technology can be essentially embodied in the form of a software product. This computer software product can be stored on a storage medium and includes multiple instructions for enabling the electronic device (e.g., a personal computer, a server, or a network device) to execute some or all of the method of embodiments of the present disclosure. The storage medium can include various media capable of storing program codes, such as a mobile storage device, a ROM, a disk, or an optical disc.

The above description is only embodiments of the present disclosure, but the scope of the present disclosure is not limited to this. Those skilled in the art can easily think of modifications or replacements within the technical scope of the present disclosure. These modifications and replacements are within the scope of the present disclosure.

What is claimed is:

1. An image processing device comprising:
a first memory, the first memory being used to store to-be-processed data of a plurality of first images; and
a scaling control component, the scaling control component being configured to read the to-be-processed data of the plurality of first images from the first memory, determine an image scaling factor corresponding to each of the first images, and send the to-be-processed data of each of the first images and its corresponding image scaling factor to a scaling component, wherein the scaling component is configured to perform scaling processing on the to-be-processed data of the corresponding first image based on the image scaling factor to obtain a target image, the target image including each target object in the first image, each target object being displayed in the target image based on a target ratio.

2. The device of claim 1, wherein:
the first memory includes one or more first data storage areas, an arrangement order of the one or more first data storage areas corresponding to an order in which the scaling control component reads the image data from the first memory, wherein:
each of the first data storage area is used to store the to-be-processed data of at least one first image, the scaled images corresponding to each of the first images is arranged in an array in the target image, and the scaled images corresponding to at least one first image stored in the same first data storage area is arranged along a first direction of the target image.

3. The device of claim 2 further comprising:
a second memory, the second memory being used to store a plurality of to-be-processed first images; and
a read control component, the read control component being configured to read idle state information of the first memory, read the to-be-processed data of at least one first image from the second memory, and store the read to-be-processed data of the at least one first image in the first memory when the idle state information indicates that the first memory has an idle storage space not less than a specified threshold.

4. The device of claim 3, wherein the read control component is configured to:
store the to-be-processed data of each first image read into the corresponding first data storage area based on a reading order to the to-be-processed data of the at least one first image read from the second memory and the arrangement order of the one or more first data storage areas.

5. The device of claim 2, wherein:
the plurality of first images include a plurality of first sub-images, the to-be-processed data of the plurality of first sub-images being stored in different first data storage areas;
the scaling control component is configured to read at least part of the to-be-processed data of each first sub-image from each first data storage area based on the arrangement order of the one or more first data storage areas, and send at least part of the to-be-processed data of each first sub-image to the scaling component for scaling processing, the scaled images corresponding to the plurality of first sub-images being arranged along a second direction in the target image, the second direction being different from the first direction.

6. The device of claim 2, wherein:
the plurality of first images includes a second sub-image and a third sub-image, the first data storage area corresponding to the second sub-image being arranged before the first data storage area corresponding to the third sub-image; and
the scaling control component is further configured to:
in response to a scaling processing completion signal output by the scaling component for a first part of the data of the second sub-image, read a second part of the data of the third sub-image from the first memory and determine the image scaling factor corresponding to the third sub-image, the amount of the first part of the data being determined based on the image scaling factor corresponding to the second sub-image, the amount of the second part of the data being determined based on the image scaling factor corresponding to the third sub-image; and
send the second part of the data read and its corresponding image scaling factor to the scaling component.

7. The device of claim 6, wherein the scaling component is further configured to:
generate first indication information in response to a completion of the scaling processing for the first part of the data of the second sub-image, the first indication information being used to indicate processing position information of at least a part of the received image data of the second sub-image.

8. The device of claim 2, wherein:
the scaling component includes a third memory, the third memory being used to store processed data of at least one first image corresponding to at least one row of pixels along the second direction in the target image; and
the scaling control component is further configured to, in response to the scaling component completing the scaling processing of a first data set of at least one first image, update a second data set stored in the third memory using the first data set, the second data set representing image data of at least one first image that precedes the first data set in a processing order.

9. The device of claim 1, wherein:
each of the first images has corresponding original size information; and
the scaling control component is further configured to obtain preset target size information for the target image, and determine the image scaling factor corresponding to each of the first images based on the original size information of each of the first images and the target size information.

10. The device of claim 1 further comprising:
a driver, the driver being configured to read the target image from the scaling component to send the target image to a corresponding application for display output.

11. An image processing method comprising:
reading, by a scaling control component in an electronic device, to-be-processed data of a plurality of first images from a first memory, and determining an image scaling factor corresponding to each of the first images; and
performing, by a scaling component in the electronic device, scaling processing on the to-be-processed data of the corresponding first image based on the image scaling factor to obtain a target image, the target image including each target object in the first image, each target object being displayed in the target image based on a target ratio.

12. The method of claim 11, wherein:
the first memory includes one or more first data storage areas, an arrangement order of the one or more first data storage areas corresponding to an order in which the scaling control component reads the image data from the first memory, wherein:
each of the first data storage area is used to store the to-be-processed data of at least one first image, the scaled images corresponding to each of the first images is arranged in an array in the target image, and the scaled images corresponding to at least one first image stored in the same first data storage area is arranged along a first direction of the target image.

13. The method of claim 12 further comprising:
reading, by a read control component, idle state information of the first memory and the to-be-processed data of at least one first image from a second memory, and storing the read to-be-processed data of the at least one first image in the first memory when the idle state information indicates that the first memory has an idle storage space not less than a specified threshold, the second memory being used to store a plurality of to-be-processed first images.

14. The method of claim 13, wherein using the read control component to read the to-be-processed data of at least one first image from the second memory and storing the read to-be-processed data of the at least one first image in the first memory includes:
storing the to-be-processed data of each first image read into the corresponding first data storage area based on a reading order to the to-be-processed data of the at least one first image read from the second memory and the arrangement order of the one or more first data storage areas.

15. The method of claim 12, wherein:
the plurality of first images include a plurality of first sub-images, the to-be-processed data of the plurality of first sub-images being stored in different first data storage areas; and
using the scaling control component to read the to-be-processed data of the plurality of first images from the first memory includes:
reading at least part of the to-be-processed data of each first sub-image from each first data storage area based on the arrangement order of the one or more first data storage areas, the scaled images corresponding to the plurality of first sub-images being arranged along a second direction in the target image, the second direction being different from the first direction.

16. The method of claim 12, wherein:
the plurality of first images includes a second sub-image and a third sub-image, the first data storage area corresponding to the second sub-image being arranged before the first data storage area corresponding to the third sub-image; and
the method further comprising:
in response to a scaling processing completion signal output by the scaling component for a first part of the data of the second sub-image, reading a second part of the data of the third sub-image from the first memory and determine the image scaling factor corresponding to the third sub-image, the amount of the first part of the data being determined based on the image scaling factor corresponding to the second sub-image, the amount of the second part of the data being determined based on the image scaling factor corresponding to the third sub-image; and
sending the read second part of the data and its corresponding image scaling factor to the scaling component.

17. The method of claim 16 further comprising:
generating first indication information in response to a completion of the scaling processing for the first part of the data of the second sub-image, the first indication information being used to indicate processing position information of at least a part of the received image data of the second sub-image.

18. The method of claim 12, wherein:
the scaling component includes a third memory, the third memory being used to store processed data of at least one first image corresponding to at least one row of pixels along the second direction in the target image; and
the method further comprising:
in response to the scaling component completing the scaling processing of a first data set of at least one first image, updating a second data set stored in the third memory using the first data set, the second data set representing image data of at least one first image that precedes the first data set in a processing order.

19. The method of claim 11, wherein:
each of the first images has corresponding original size information; and
the method further comprising:
obtaining preset target size information for the target image, and determining the image scaling factor corresponding to each of the first images based on the original size information of each of the first images and the target size information.

20. An electronic device comprising:
one or more processors; and
one or more memories coupled to the one or more processors and storing a plurality of computer instructions that, when being executed, cause the one or more processors to:
read to-be-processed data of a plurality of first images from a first memory;
determine an image scaling factor corresponding to each of the first images; and
perform scaling processing on the to-be-processed data of the corresponding first image based on the image scaling factor to obtain a target image, the target image including each target object in the first image, each target object being displayed in the target image based on a target ratio.
